(19) United States
(12) Patent Application Publication
(10) Pub. No.: US 2003/0169883 A1
(43) Pub. Date: Sep. 11, 2003

(54) In-light encryption/decryption system for data distribution

(76) Inventors: Jean-Yves Leroux, Ceyreste (FR); Laurent Jabiol, Ceyreste (FR)

Correspondence Address: GREENBLUM & BERNSTEIN, P.L.C., 1950 ROLAND CLARKE PLACE, RESTON, VA, 20191, US

(21) Appl. No.: 10/181,940

(22) PCT Filed: Jul. 31, 2001
(86) PCT No.: PCT/FR01/02503

(30) Foreign Application Priority Data
Jul. 31, 2000 (FR) 00/10034

(51) Int. Cl. H04L 9/00

(52) U.S. Cl. 380/277

(57) ABSTRACT

The invention concerns an in-flight encryption/decryption system for data distribution. It generally concerns the field of data transmission of all types in digital form using packet-data encoding consisting of data routed in blocks in a network, and in particular the distribution of encrypted data by satellite. To accelerate the key-exchanging period, the keys are not distributed on a channel parallel to the data channel but inside the very data, encrypted then transmitted in the form of packets (12) containing each a key (14) and useful data (15) encrypted with said key, the latter capable of being changed for each packet and being recovered in reception by a specific hardware or software element.

The present invention relates to an in-flight encryption/decryption system for distributing data.

Generally, it relates to the field of transmission of all types of digital data using packet encoding constituted of a set of data routed in blocks in a network, and particularly to the distribution of encrypted data by satellite. Currently, the encryption of distributed data is widely used by service providers, for example, for digital television packages or movies and soccer games on a pay-per-view basis.

The access controls used by these distributors often function on a principle of encryption by command words.

The data 1, generally audio and video for the moment, is encoded when transmitted by a flow generator 2 by means of encryption keys 3, and deciphered upon receipt due to the parallel distribution of a flow of decryption keys 4 allowing the client system 5 to find the command words, or keys, making it possible to decipher the data 6 received in order to obtain clear text data 20. These systems generally use a chip 7 that allows reconstructing the keys based on the encrypted words (FIG. 1).

In order to improve security, these keys are changed regularly, for example, every ten seconds, or every five seconds; this is called “encryption time.”

This encryption time is usually limited by the client system 5 that needs time to recover the encrypted words (parametrizing filters and recovering the data) and to send them to the chip 7 that generates the key to be used by the decoder 8.

The system according to the present invention allows obtaining a secured data transfer based on an encryption, whose key-exchanging period is shorter than current known systems.

In order to accelerate the period for changing the keys, the latter are not distributed over a channel parallel to that of the data but inside the data itself, encrypted then transmitted in the form of packets, each one containing a key and the useful data encrypted with this key, the latter being capable of being changed for each packet and being recovered in reception by a specific hardware or software device.

In the attached diagrams, which are given by way of non-limiting examples of embodiments of the object of the invention:

FIG. 1, already mentioned, shows a known system for distributing data by satellite,

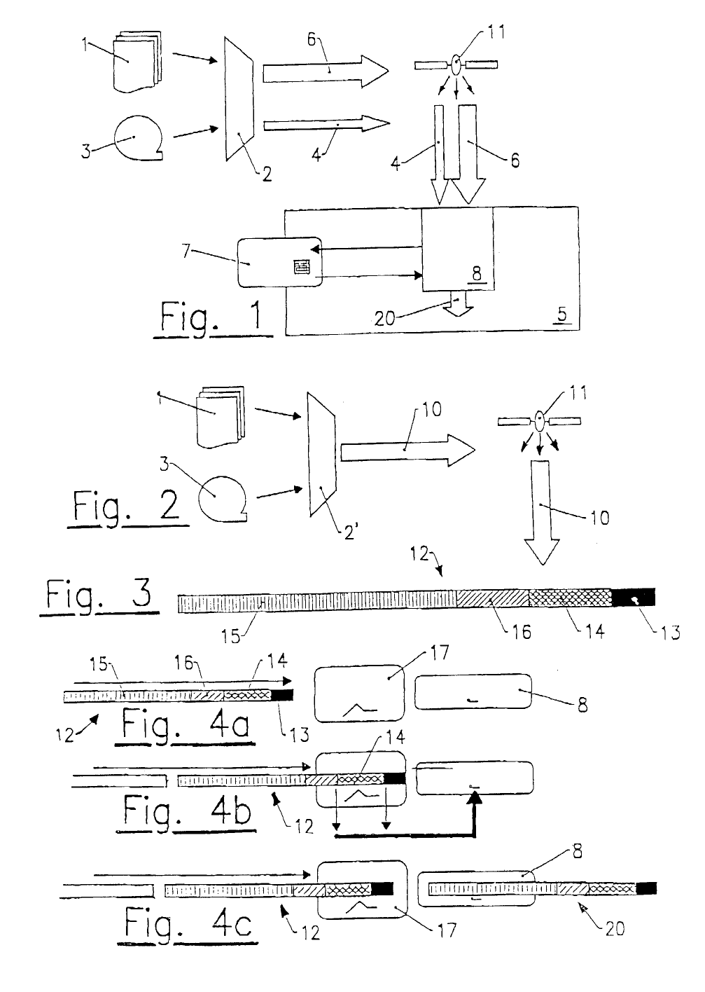

FIG. 2 shows an example of satellite transmission system with a single transmission channel for the data and decryption keys,

FIG. 3 shows a data packet with an integrated key,

FIGS. 4a, 4b and 4c show the progression of a packet in a receiving station,

FIGS. 5a, 5b and 5c show the transmission station, a packet and the receiving station of a transmission system that uses variable packet identifiers, respectively,

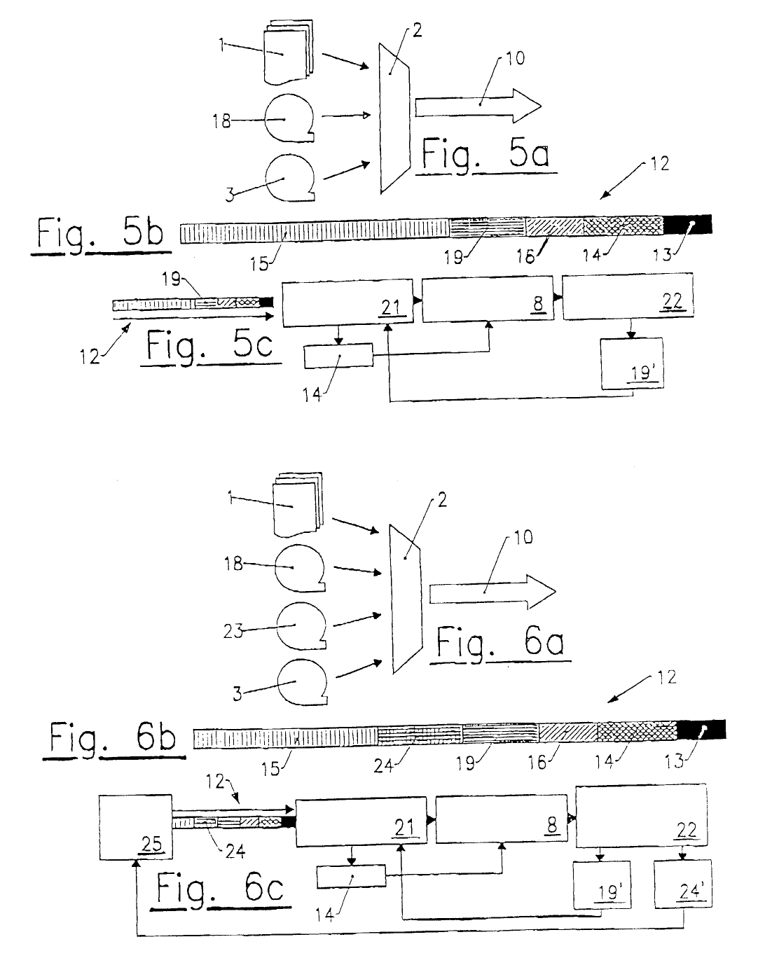

FIGS. 6a, 6b and 6c show the transmission station, a packet and the receiving station of a transmission system using variable packet identifiers and frequency channels, respectively.

FIG. 2 shows an example of application of the invention to a station for transmitting a flow of encrypted data 10 transmitted by satellite 11.

The data 1 is encoded when transmitted by a flow generator 2′ by means of encryption keys 3 distributed inside the data itself that is encrypted and transmitted in the form of packets 12. Each packet therefore contains, in addition to the header 13, a key 14 and useful data 15 encrypted with this key (FIG. 3), the transmission station being arranged to allow a change of key 14 for each packet 12, and this at the highest rates possible.

In order to use these keys upon receipt, one can envision a hardware solution that allows recovering the key contained in a packet and using it in-flight on useful data 15 of this same packet. This method allows ensuring a high level of security without using software or chips, especially at high rates.

However, depending on the capacities of the receiving system and the rate used, a software solution can be envisioned.

The packet 12 can comprise, between the key 14 and the data 15, an empty space or gap 16 that allows an electronic filter 17 of the receiving system to have the time to recover the decryption key and to use it in the decoder 8 of the receiving system in order to obtain the clear text data 20, before the encrypted data can reach the latter (FIGS. 4a, 4b, 4c).

Another method can be used if the propagation of data is too quick for the receiver. It consists of storing each packet 12 of data in a buffer memory as long as the new key has not been loaded before releasing it toward the decoder 8.

The decryption method then occurs in the following manner:

storing the packet 12 in the buffer memory after retrieving the key,

loading the key bytes in the decoder 8,

releasing the buffer memory through the decoder.

If the consecutive packets 12 are very close in time, access to the decoder 8 must be protected: as long as the packet N has not been completely propagated through the decoder, the key must not be changed. In this case, the use of a buffer memory becomes almost mandatory.

It is also possible to use two decoders alternatively, the packets 12 being transmitted alternately toward each of the decoders. This method can be useful if the storing does not prove to be adequately efficient.

In the field of distribution by satellite (digital television, various types of data, etc.), the data is distributed in transport packets 12 of 188 bytes (MPEG coding), which have at their header 13 an identifier over 13 bits called a PID (packet identifier) allowing the packets to be selected.

For example, for a television network, the video flow is distributed over the PID 400 and the audio flow over the PID 401.

In the case where a person of ill-intent decides to “pirate” the system described previously, if the rate is too high to duplicate in real time the behavior of the hardware receiving system with a software system (for instance, with a satellite receiving chip, a private computer and a program allowing the software filtering of the keys and their automatic use on each packet received), the counterfeiter still has the possibility of registering the flow on the PID of the desired data, and then of applying an appropriate program to these encrypted and stored data.

Let us imagine that the transmitter system allows multiplexing the data to be transmitted over different PIDs. For example, the packets of a video flow are not all in sequence on a given PID but are found in time on different PIDs. One could also imagine that the PID of a packet is contained in the encrypted data of the previous packet.

As for the receiving system, it is capable of decrypting each packet in-flight (method described hereinabove). Still by means of hardware, it recovers the information PID 19 of the following packet in the decrypted data of the current packet.

In this case, and at rather high rate levels, the counterfeiter who has decided to record the flow in order to decipher the data later must now register all of the PIDs in which the data is distributed, and must have more substantial means for receiving and storing than if the data were contained in a single known PID.

One can see in FIGS. 5a, 5b, 5c an example of architecture of variable packet identifiers.

The flow generator 2 is fed by the data 1, the encryption keys 3, as well as by a random PID generator 18.

Upon receipt, the packets 12 pass successively through a first filter 21, through the decoder 8, then through a second filter 22. The first filter 21 retrieves the key 14 corresponding to the identifier (PID) of the previous packet, the decrypted data zone 19′ being retrieved by the second filter and sent back to the first filter.

Currently, the data of a particular satellite flow (for example, the video of a given station) is not only distributed with a known packet identifier (PID), but also over a predetermined channel (each channel corresponding to a given frequency used by the receiving tuners).

To further improve the security of data transmission with respect to the method using multiple identifiers, it is possible to transmit and receive the data packets over variable channels, for example, the N packet is distributed over channel X and the packet N+1 over channel Y. This technique can be used alone or in conjunction with the previous one, as is the case in FIGS. 6a, 6b and 6c.

The transmission station therefore comprises a random generator 23 of channel numbers (FIG. 6a), the “data channel” 24 for each packet 12 is therefore contained in the encrypted data of the previous packet. Once again a quick hardware technique can be selected to quickly direct the receiving system to the desired frequency.

The receiving system is provided with a second filter 22′ capable of retrieving the decrypted “data channel” 24′ from a packet in order to send it to the tuner 25.

Currently, the time for setting a tuner 25 to a given frequency is often greater than the distance between two packets of a specific data flow (for example, between two packets of a video flow). Nevertheless, it is possible to limit the solution to a less frequent channel change and to sufficiently distance packets of a data flow when there is a channel change. A solution of two tuners used alternately can also accelerate the capture of packets.

The positioning of the various components gives the object of the invention a maximum of useful effects that, until now, had not been obtained by similar devices.

1. In-flight encryption/decryption system for distributing data, having the object of transmitting all types of digital data using packet encoding constituted of a set of data routed in blocks in a network, and particularly the distribution of encrypted data by satellite,
characterized in that the decryption keys (14) are not distributed over a channel parallel to that of the data flow (10) but inside the data itself, encrypted then transmitted in the form of packets (12), each one containing a key and the useful data (15) encrypted with the key, the latter being capable of being changed for each packet (12) and being recovered upon receipt by a specific hardware or software device.

2. System according to claim 1, characterized in that the transmission station is arranged to allow a change of key (14) for each packet (12).

3. System according to claim 2, characterized in that the receiving device comprises a hardware element allowing to recover the key (14) contained in a packet (12) and to use it in-flight on the useful data (15) of this same packet, so as to allow a change of key for each packet.

4. System according to claim 2, characterized in that the receiving device comprises a software element that allows recovering the key (14) contained in a packet (12) and to use it in-flight on useful the data (15) of this same packet, so as to allow a change of key for each packet.

5. System according to any of claims 1 and 2, characterized in that the reception device comprises a buffer memory capable of storing each data packet (12) as long as a new key (14) has not been loaded, before releasing it toward the decoder (8), allowing the obtention of clear text data (20).

6. System according to any of the preceding claims, characterized in that the packets (12) comprise, between the key (14) and the data (15), an empty space or gap (16) allowing the receiving device to have the time to recover the decryption key and to use it in a decoder (8).

7. System according to any of the preceding claims, characterized in that it is used for transmitting packets, the header of which comprises an identifier that allows the packets (12) (identifier called PID in the case of an MPEG flow) to be selected, and in that it is arranged to be able to change this identifier for each packet transmitted, the transmission station comprising a possibly random generator (18) for identifiers and inserting in each packet a data zone (19) relevant to the identifier of the following packet, the receiving device being equipped with a first filter (21) capable of retrieving the key (14) corresponding to the previous packet, the decrypted data zone (19′) being retrieved by a second filter (22) and sent back to the first filter.

8. System according to any of the preceding claims, characterized in that it is used for transmitting packets that can be transmitted over several channels of different frequencies, and in that it is arranged to be able to change channels for each packet sent, the transmission station comprising a random generator (23) of channel numbers and inserting in each packet a “data channel” zone (24) relative to the channel of the following packet, the receiving device being equipped with a first filter (21) capable of retrieving the key (14) corresponding to the channel of the preceding packet, the decrypted “data channel” (24′) being retrieved by a second filter (22) and transmitted to the tuner (25) of the receiving device.

9. System according to claims 7 and 8, characterized in that it is used for transmitting packets, the header of which comprises an identifier (PID) that allows the packets (12) to be selected, and in that it is arranged to be able to change both this identifier and the distribution channel for each packet transmitted, the transmission station comprising a random generator (18) for identifiers and a random generator (23) for channel numbers, the second filter (22) being capable of retrieving the decrypted data zone (19′) of the identifier, as well as of the decrypted “data channel” (24′).

10. System according to any of the preceding claims, characterized in that the receiving device is equipped with two decoders (8), the packets (12) being transmitted alternately toward each of said decoders.
